(19) United States
(12) Patent Application Publication
(10) Pub. No.: US 2026/0192548 A1
(43) Pub. Date: Jul. 9, 2026

(54) LAMINATED GLASS AND METHOD FOR PRODUCING LAMINATED GLASS

(71) Applicant: AGC Inc., Tokyo (JP)

(72) Inventor: Yukihiro SUMI, Tokyo (JP)

(73) Assignee: AGC Inc., Tokyo (JP)

(21) Appl. No.: 19/554,530

(22) Filed: Mar. 2, 2026

Related U.S. Application Data
(63) Continuation of application No. PCT/JP2024/031536, filed on Sep. 3, 2024.

(30) Foreign Application Priority Data
Sep. 6, 2023 (JP) 2023-144340

(51) Int. Cl. B32B 17/10; B32B 7/12

(52) U.S. Cl. CPC B32B 17/10036; B32B 7/12; B32B 17/10779; B32B 17/10798; B32B 2250/04; B32B 2274/00; B32B 2307/71; B32B 2307/7376

(57) ABSTRACT

Provided is a laminated glass with reduced deterioration of a functional member and with excellent aesthetics. The laminated glass includes: first glass plate, adhesive interlayer, functional layer, second glass plate and sealing member, wherein: first glass plate has a first main surface, a second main surface and a first end surface connecting the first main surface and the second main surface; second glass plate has a third main surface, a fourth main surface and a second end surface connecting the third main surface and the fourth main surface; adhesive interlayer is in contact with the second and third main surfaces; functional layer is positioned between the second main surface and the third main surface; sealing member is in contact with the first and second end surfaces; the sealing member is arranged continuously from the first main surface to the fourth main surface; and the sealing member contains a resin material.

### CROSS-REFERENCE TO RELATED PATENT APPLICATIONS

This application is a continuation of PCT Application No. PCT/JP2024/031536, filed on Sep. 3, 2024, which is based upon and claims the benefit of priority from Japanese Patent Application No. 2023-144340 filed on Sep. 6, 2023. The contents of those applications are incorporated herein by reference in their entireties.

### TECHNICAL FIELD

The present invention relates to a laminated glass and a method for producing a laminated glass.

### BACKGROUND ART

A laminated glass, which has an interlayer film such as a resin film laminated between multiple glass plates by heat and pressure bonding and, even when broken, does not scatter fragments, is excellent in safety and widely used for windows of vehicles such as automobiles. In recent years, layers of functional members (called functional layers) capable of performing various functions by transfer of electric power from or to external power supplies have been arranged between glass plates of laminated glasses. It is however known that the functional members deteriorate due to moisture (water vapor or liquid water) and lose their function.

For example, Patent Document 1 discloses a window glass having incorporated therein a film member (hereinafter also referred to as a light control film) capable of switching its light transmittance according to a voltage applied from an external power supply. The light control film is known to deteriorate due to moisture and the like, resulting in e.g. a smaller difference in light transmittance between ON and OFF states. The deterioration of the light control film may reach visually recognizable dimensions and levels, which could adversely affect aesthetics.

As countermeasures against such a problem, various methods have been explored including: reducing the water content in the interlayer film disposed around the light control film (see Patent Document 2); sealing a peripheral edge portion of the light control film (see Patent Documents 3 and 4); and arranging a barrier layer on the end surface of the light control film (see Patent Document 5).

### PRIOR ART DOCUMENTS

### Patent Documents

Patent Document 1: JP-A-2012-503123
Patent Document 2: JP-A-2013-505188
Patent Document 3: Japanese Patent No. 5619735
Patent Document 4: JP-A-2015-531701
Patent Document 5: JP-A-2017-186229

### DISCLOSURE OF INVENTION

### Technical Problem

However, in a state that the interlayer film is exposed to the external environment, water vapor or liquid water can easily penetrate the interlayer film to cause deterioration of the functional member.

The present invention has been made in view of the above-described problem. It is an object of the present invention to provide a laminated glass in which deterioration of a functional member is reduced.

### Solution to Problem

According to one aspect of the present disclosure, there is provided a laminated glass [1] comprising a first glass plate, an adhesive interlayer, a functional layer, a second glass plate and a sealing member,
the first glass plate having a first main surface, a second main surface and a first end surface connecting the first main surface and the second main surface,
the second glass plate having a third main surface, a fourth main surface and a second end surface connecting the third main surface and the fourth main surface,
the adhesive interlayer being arranged in contact with the second main surface and the third main surface,
the functional layer being positioned between the second main surface and the third main surface, and
the sealing member containing a resin material and being arranged continuously from the first main surface to the fourth main surface to be in contact with the first end surface and the second end surface.

According to another aspect of the present disclosure, there is provided a laminated glass [2] as in the laminated glass [1], wherein the sealing member is in contact with the first and second end surfaces around the entire peripheries of the first and second glass plates.

According to another aspect of the present disclosure, there is provided a laminated glass [3] as in the laminated glass [1] or [2], wherein the sealing member is in contact with at least one of the first main surface and the fourth main surface.

According to another aspect of the present disclosure, there is provided a laminated glass [4] as in the laminated glass [3], wherein a portion of the sealing member in contact with the at least one of the first main surface and the fourth main surface has a slope that decreases in thickness inwardly.

According to another aspect of the present disclosure, there is provided a laminated glass [5] as in any one of the laminated glasses [1] to [4], wherein the sealing member has an intermediate protruding portion that protrudes between the first glass plate and the second glass plate.

According to another aspect of the present disclosure, there is provided a laminated glass [6] as described in any one of the laminated glasses [1] to [5], comprising an adhesion layer between the sealing member and the first glass plate and between the sealing member and the second glass plate.

According to another aspect of the present disclosure, there is provided a laminated glass [7] as in any one of the laminated glasses [1] to [6], wherein the sealing member contains at least one resin selected from a thermoplastic elastomer (TPE), polyvinyl chloride (PVC), polyurethane (PU), polypropylene (PP), an ethylene-propylene rubber (EPDM), an acrylonitrile-butadiene-styrene resin (ABS) and a thermoplastic vulcanizate (TPV).

According to another aspect of the present disclosure, there is provided a laminated glass [8] as in any one of the laminated glasses [1] to [7], wherein the sealing member is an injection molded resin member.

According to another aspect of the present disclosure, there is provided a laminated glass [9] as in any one of the laminated glasses [1] to [8], wherein:
a peripheral edge portion of the functional member is apart from the sealing member; and
the adhesive interlayer is in contact with the sealing member.

According to another aspect of the present disclosure, there is provided a laminated glass [10] as in any one of the laminated glasses [1] to [9], wherein, in plan view, a peripheral edge portion of the functional layer overlaps the sealing member.

According to another aspect of the present disclosure, there is provided a laminated glass [11] as in any one of the laminated glasses [1] to [10], wherein a width of overlap between the sealing member and the functional layer in plan view is 1 mm or more.

According to another aspect of the present disclosure, there is provided a laminated glass [12] as in any one of the laminated glasses [1] to [11], wherein the functional layer comprises at least one selected from a light control film, a light emitting film and a solar cell.

According to another aspect of the present disclosure, there is provided a laminated glass [13] as in any one of the laminated glasses [1] to [12], wherein:
the functional layer is a light control film; and
the light control film contains at least one selected from a suspended particle device, polymer-dispersed liquid crystal, polymer-network liquid crystal, guest-host liquid crystal and an electrochromic material.

According to one aspect of the present disclosure, there is provided a laminated glass production method <1>, comprising:
a stacking step of preparing a layered body in which a first glass plate, a first resin sheet, a functional layer, a second resin sheet and a second glass plate are stacked in order of mention, the first glass plate having a first main surface, a second main surface and a first end surface connecting the first main surface and the second main surface, the second glass plate having a third main surface, a fourth main surface and a second end surface connecting the third main surface and the fourth main surface;
a bonding step of, after the stacking step, forming the resin sheets into an adhesive interlayer between the first glass plate and the second glass plate such that the adhesive interlayer is in contact with the second and third main surfaces and bonds the first and second glass plates together; and
a sealing step of, after the bonding step, forming a sealing member with a resin material continuously from the first main surface to the fourth main surface to be in contact with at least the first and second end surfaces.

According to another aspect of the present disclosure, there is provided a laminated glass production method <2> as in the laminated glass production method <1>, wherein, in the sealing step, the sealing member is formed by allowing a mold to hold a peripheral edge portion of the layered body, thereby forming a cavity defined by the mold and the layered body, and filling the cavity with the resin material in a molten state.

According to another aspect of the present disclosure, there is provided a laminated glass production method <3> as in the laminated glass production method <2>, wherein, in the sealing step, the mold holds the layered body without contacting at least one of peripheral edges of the first and second glass plates and without, in plan view, a contact area of the mold with at least one of the first and fourth main surfaces overlapping a peripheral edge of the functional layer.

### Advantageous Effects of Invention

According to one aspect of the present invention, it is possible to provide a laminated glass in which deterioration of a functional member is reduced.

### BRIEF DESCRIPTION OF DRAWINGS

FIG. 1 is a plan view of a laminated glass according to a first embodiment.

FIG. 2 is a cross-sectional view of the laminated glass according to the first embodiment.

FIG. 3 is a cross-sectional view illustrating a configuration example of a functional layer.

FIG. 4 is a cross-sectional view of a laminated glass according to a first modification of the first embodiment.

FIG. 5 is a plan view of a laminated glass according to a second embodiment.

FIG. 6 is a cross-sectional view of the laminated glass according to the second embodiment.

FIG. 7 is a cross-sectional view of a laminated glass according to a first modification of the second embodiment.

FIG. 8 is a cross-sectional view of a laminated glass according to a second modification of the second embodiment.

FIG. 9 is a flowchart of a process for producing a laminated glass according to one embodiment of the present invention.

FIGS. 10A to 10C are schematic views illustrating the process for producing a laminated glass.

### DESCRIPTION OF EMBODIMENTS

In the present specification, the term “cross section” refers to a cut surface of a laminated glass as cut in a certain direction. The term “peripheral edge” refers to an outermost side of a certain member. The term “peripheral edge portion” refers to a peripheral edge and its vicinity. In the case of the certain member having a frame shape with a width, the peripheral edge may also be referred to as an “outer edge” as distinguished from an “inner edge” that is an innermost side. The expressions “same shape” and “same size” respectively mean identical in shape and size as seen by the human eye. Unless otherwise specified, the expression “substantially the same” means the same as seen by the human eye. The wording “to”, when expressing a numerical range, means including both the upper and lower limits of the numerical range.

The laminated glass of the present invention is usable as windowpanes of buildings and windowpanes of vehicles (including windshields, side windows, quarter windows, roof windows, rear windows, extra windows located behind rear windows, and the like) and is particularly suitably usable as windowpanes of vehicles. Here, the term “vehicle” refers to a mobile object in which laminated glass can be installed, such as an automobile, a train, a ship, an airplane or the like. The laminated glass of the present invention is particularly suitable for use as windowpanes of vehicles

In the following, embodiments of the laminated glass of the present invention will be described with reference to the drawings. It should be noted that the embodiments shown in the drawings are schematized for clear illustration of the present invention and do not necessarily represent the accurate sizes or reduction scales of the actual product.

### First Embodiment

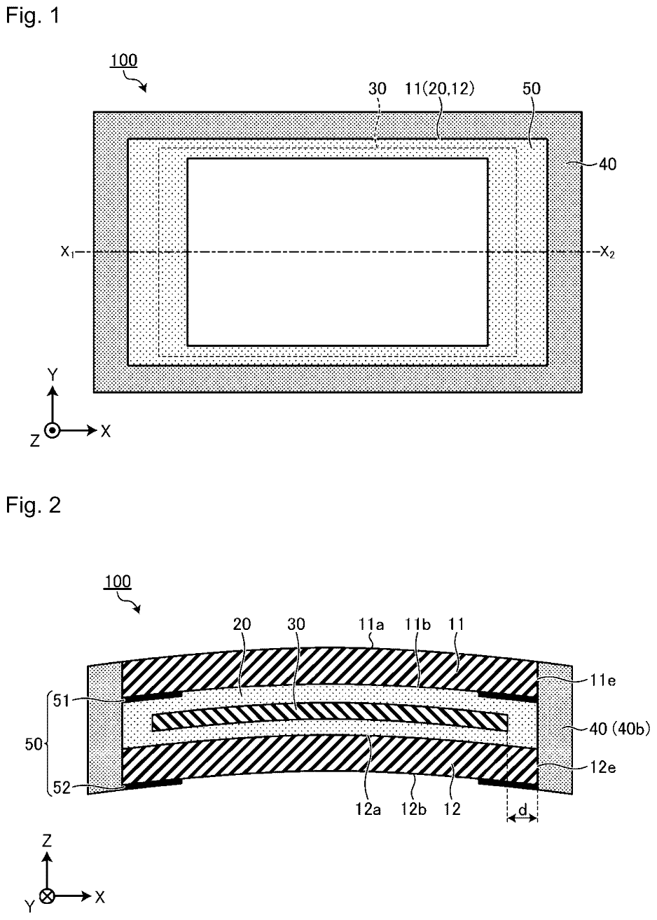

The first embodiment will be now described below with reference to FIGS. 1 to 3.

FIG. 1 is a plan view of a laminated glass 100 according to the first embodiment. In FIG. 1, when the laminated glass 100 is installed in a vehicle, a direction along the body of the vehicle is referred to as an X-axis direction; a direction along the body of the vehicle and perpendicular to the X-axis direction is referred to as a Y-axis direction; and a direction vertical to the XY-plane is referred to as a Z-axis direction (the same applies to the other drawings). The laminated glass 100 shown in FIG. 1 is, for example, a quarter window of a vehicle.

The laminated glass 100 of the first embodiment includes a first glass plate 11, an adhesive interlayer 20, a functional layer 30, a second glass plate 12 and a sealing member 40. A peripheral edge of the functional layer 30 is indicated by a dotted line. The laminated glass 100 has a rectangular shape in plan view, but is not limited to such a shape. The laminated glass 100 may be triangular or trapezoidal in shape depending on the type and part of the object in which the laminated glass is to be installed. Here, the illustrated planar shapes do not require geometric precision as to distinctions between straight lines and curves, whether edges are parallel or not, angles of vertices, and the like.

Further, the expression “in plan view” as used herein means viewing a certain region of a certain member (for example, the first glass plate 11) in the direction of a normal line of the certain member and, in other words, means viewing a certain region of a certain member in the minus Z-axis direction (e.g. the direction from the first glass plate 11 toward the second glass plate 12). The expression “in cross-sectional view” as used herein means viewing a certain cross section of the laminated glass 100 in a direction perpendicular to the cross section, for example, viewing an XZ-cross section of the laminated glass 100 in the plus Y-axis direction.

The first glass plate 11 and the second glass plate 12 have substantially the same shape and size, and are arranged with main surfaces thereof facing each other. Accordingly, peripheral edges of the first and second glass plates 11 and 12 correspond in position to each other in FIG. 1. The shape of the first and second glass plates 11 and 12 can be any shape and is preferably, for example, a rectangular shape, a trapezoidal shape or a triangular shape.

The adhesive interlayer 20 is a layer for bonding multiple glass plates together and includes, for example, one or more resin sheets. The adhesive interlayer 20 and the functional layer 30 are positioned between the first glass plate 11 and the second glass plate 12. The adhesive interlayer 20 is substantially the same in shape and size as the first and second glass plates 11 and 12, whereas the functional layer 30 is smaller in size than the first and second glass plates 11 and 12. A peripheral edge of the adhesive interlayer 20 corresponds in position to the peripheral edges of the first and second glass plates 11 and 12. In plan view, the functional layer 30 overlaps the adhesive interlayer 20 such that a peripheral edge of the functional layer 30 is located more inward than the peripheral edge of the adhesive interlayer 20.

The term “inward” as used herein refers to, in plan view, a direction toward the center of the laminated glass 100 as seen from the peripheral edge of a certain member (for example, the first glass plate 11). Conversely, the term “outward” as used herein refers to, in plan view, a direction away from the center of the laminated glass 100 as seen from the peripheral edge of a certain member (for example, the first glass plate 11).

However, the first glass plate 11, the second glass plate 12 and the adhesive interlayer 20 do not necessarily have substantially the same shape and size. For example, the second glass plate 12 and the adhesive interlayer 20 may be smaller in size than the first glass plate 11. The adhesive interlayer 20 may be smaller in size than the second glass plate 12. The functional layer 30 may be smaller in size than at least one of the first glass plate 11, the second glass plate 12 and the adhesive interlayer 20 and have its peripheral edge at least partially corresponding in position to the peripheral edge of the adhesive interlayer 20. The functional layer 30 may be substantially the same in shape and size as at least one of the first glass plate 11, the second glass plate 12 and the adhesive interlayer 20.

A thermoplastic resin is often used as the material of the resin sheet in the adhesive interlayer 20. Examples of the thermoplastic resin include a polyvinyl butyral (PVB) resin, an ethylene vinyl acetate copolymer (EVA) resin, a polyurethane resin, an ionomer resin, a cycloolefin polymer resin and the like. The thermoplastic resin is selected in consideration of balance of various properties such as glass transition point, transparency, weather resistance, adhesion, penetration resistance, impact energy absorption, moisture resistance and thermal insulation. In view of the balance of the above various properties, a PVB resin, an EVA resin and a polyurethane resin are preferred. Particularly preferred are a PVB resin and an EVA resin.

The resin sheet may contain a conventionally known plasticizer such as triethylene glycol di-2-ethylhexanoate and various additives such as an antioxidant, a light stabilizer, an adhesion modifier and a crosslinking agent. Particularly in the case where a PVB resin is used, it is preferable that the resin sheet contains a plasticizer. The resin sheet may contain functional particles such as an infrared absorber, an ultraviolet absorber, a luminescent agent or the like. The adhesive interlayer 20 may be formed by using two or more types of resin sheets in combination.

As the material of the first and second glass plates 11 and 12, conventionally known inorganic or organic glass for vehicle windowpanes can be selected. The composition of the first glass plate 11 may be the same as or different from the composition of the second glass plate 12. Examples of the inorganic glass include, but are not limited to, soda-lime glass, aluminosilicate glass, borosilicate glass, alkali-free glass and quartz glass.

The material of the glass plate to be located on the vehicle exterior side is preferably inorganic glass from the viewpoint of scratch resistance and is preferably soda-lime glass from the viewpoint of formability. In the case where the glass plate is made of soda-lime glass, clear glass, green glass containing a predetermined amount or more of iron component or a UV-cut green glass can suitably be used. Here, the UV-cut green glass refers to a UV-absorbing green glass containing 68 mass % to 74 mass % of SiO₂, 0.3 mass % to 1.0 mass % of Fe₂O₃ and 0.05 mass % to 0.5 mass % of FeO and having a UV transmittance of 1.5% or lower at a wavelength of 350 nm and a minimum value of transmittance in a region from 550 nm to 1700 nm.

The inorganic glass can be produced by any conventionally known method such as a float method. The inorganic glass may be bent by any known method such as a gravity forming method. The inorganic glass plate may be non-strengthened glass as obtained by forming molten glass into a plate shape and annealing the formed glass, and may be subjected to strengthening treatment such as physical strengthening treatment (e.g. air-cool tempering) or chemical strengthening treatment.

Examples of the organic glass include transparent resins such as a polycarbonate resin, an acrylic resin, a polystyrene resin, an aromatic polyester resin, a polyester resin, a polyarylate resin, a polycondensate of halogenated bisphenol A and ethylene glycol, an acrylic urethane resin and a halogenated aryl group-containing acrylic resin. As the organic glass, a polycarbonate resin is preferred to obtain a lightweight and flexible sheet. These resins can be used alone or in combination of two or more types thereof.

Both of the inorganic glass and the organic glass are normally colorless, but may be colored so far as they have transparency. As such colored glass, so-called privacy glass particularly colored in deep gray may be used. The details of privacy glass are described in e.g. WO 2015/088026, the entire contents of which are incorporated herein by reference. The privacy glass has the effect of making it difficult to see the inside of the vehicle from outside the vehicle while reducing transmission of sunlight from outside to inside the vehicle as well as the effect of enhancing aesthetics as seen from both inside and outside the vehicle.

The privacy glass is suitably used for window parts other than windshields, especially for roof windows, side windows on vehicle rear sides and rear windows. Furthermore, the inorganic glass and the organic glass may have infrared absorbing functions and ultraviolet absorbing functions.

The functional layer 30 is a layer operable by transfer of power from or to the outside of the laminated glass 100. For example, the functional layer 30 may operate upon receipt of power from a power supply outside the laminated glass 100. Examples of such a functional layer include light control films and light emitting films. The functional layer may have a power generation function and supply power to a storage battery outside the laminated glass 100. Examples of such a functional layer 30 include solar cells. It is known that many of light control films, light emitting films and solar cells deteriorate due to moisture or the like. In the case where the material of the adhesive interlayer 20 contains a plasticizer, the functional layer 30 may deteriorate due to such a plasticizer.

The transfer of power between the functional layer 30 and the outside of the laminated glass 100 may be carried out by, for example, connecting a conductive wire to the functional layer 30. The conductive wire may be of thin shape (strip shape). The conductive wire may be an insulated wire. The transfer of power between the functional layer 30 and the outside of the laminated glass 100 may be carried out in a non-contact manner via electromagnetic induction by connecting a coil to the functional layer 30. Here, the member to be connected to the functional layer 30 for power transfer is omitted from illustration.

A part of the functional layer 30 that substantially performs its function may form a plane as a whole. Each of a coating or film that blocks infrared or ultraviolet light, a resin film that emits light under ultraviolet light radiation, a resin film that enhances sound insulation and the like forms a plane as a whole but does not involve power transfer. Thus, these films themselves do not constitute the functional layer 30. However, the combined use of the functional layer 30 with a layer that does not involve power transfer is not herein excluded.

The light control film is a film having the function of changing at least one of visible light transmittance or haze when electrically driven. The light control film may exhibit color changes during driving. The light control film contains at least one type selected from, for example, liquid crystal (LC), a suspended particle device (SPD) and an electrochromic (EC) material.

Examples of the liquid crystal (LC) usable in the light control film include polymer-dispersed liquid crystal (PDLC), polymer-network liquid crystal (PNLC) and guest-host liquid crystal (GHLC).

The light control film typically has a structure in which a first base material, a first conductive layer, an active layer or an electrolyte layer, a second conductive layer and a second base material are laminated in this order. At least one of these structural members may be darkened by coloring or coating etc. to such a degree that it does not become opaque. In the case of the light control film containing liquid crystal, for example, the active layer contains at least liquid crystal and may further contain a dichroic dye or other additive.

In the configuration of the present invention, a force is less likely to act to sandwich the peripheral edge portion of the functional layer 30 from above and below. It is thus less likely that, in the case where the functional layer 30 is composed of a light control film containing liquid crystal, unevenness will occur due to uneven distribution of liquid crystal etc. In other words, it is less likely that variations in visible light transmittance or haze will occur due to the uneven distribution of liquid crystal etc. In the case of GHLC, the active layer is mostly liquid and is likely to be affected even by minor uneven distribution of liquid crystal etc. The present invention is therefore particularly effective when the functional layer 30 contains GHLC.

In the case where the functional layer 30 includes a light control film, a portion of the laminated glass 100 including the light control film has a difference in visible light transmittance (Tv) between the dark and bright states of preferably 0.1% or more, more preferably 10% or more, still more preferably 50% or more, particularly preferably 80% or more. The transmittance Tv can be measured in accordance with JIS R3212 issued in 2015. In the case where the laminated glass 100 is provided with a light blocking part 50 as will be described later, the visible light transmittance can be measured at a location more inward than the light blocking part 50, that is, a location that does not overlap the light blocking part 50 in plan view.

The light emitting film is a film that contains a material capable of emitting light when electrically driven. Examples of such a material include a light emitting diode (LED) and an organic light emitting diode (OLED). The light emitting film is preferably of the type that produces planar light emission. The light emitting film may be a display capable of showing images and videos. The light emitting film can also be used for directional guidance, warning and entertainment.

The solar cell is a layer that generates photovoltaic power. A conventionally known material such as a silicon-based, compound-based or organic-based material can be used for the solar cell.

The planar shape of the functional layer 30 is substantially similar to that of the first glass plate 11 in FIG. 1, but may be a substantially circular shape, a substantially elliptical shape, a substantially triangular shape, a substantially rectangular shape, a substantially trapezoidal shape, a substantially n-sided polygon shape (where n is an integer of 5 or greater) or the like.

The thickness of the functional layer 30 is, for example, from 0.05 mm to 1.0 mm. When the thickness of the functional layer 30 is 1.0 mm or smaller, it is less likely that breakage or bubbling will occur in the laminated glass 100. The thickness of the functional layer 30 is preferably 0.8 mm or smaller, more preferably 0.5 mm or smaller. When the thickness of the functional layer 30 is 0.05 mm or larger, good handling can be achieved. The thickness of the functional layer 30 is preferably 0.1 mm or larger.

The sealing member 40 is a member containing a resin material. The sealing member 40 is arranged in contact with the peripheral edges of the first and second glass plates 11 and 12 such that at least a part of the sealing member 40 is located more outward than the first and second glass plates 11 and 12. In such an arrangement, the sealing member 40 suppresses deterioration of the functional layer 30 caused due to penetration of moisture etc. into the adhesive interlayer 20. In the first embodiment, the entire sealing member 40 is located more outward than the first and second glass plates 11 and 12. In other words, the sealing member 40 does not overlap the first and second glass plates 11 and 12 in plan view. It is preferable that the sealing member 40 surrounds the entire peripheral edge of the adhesive interlayer 20, that is, surrounds the side surface (end surface) of the adhesive interlayer 20 continuously around the entire periphery.

The sealing member 40 may contain at least one resin selected from the group consisting of a thermoplastic elastomer (TPE), polyvinyl chloride (PVC), polyurethane (PU), polypropylene (PP), an ethylene-propylene rubber (EPDM), an acrylonitrile-butadiene-styrene (ABS) resin, a thermoplastic vulcanizate (TPV). Among others, a thermoplastic elastomer (TPE), polyvinyl chloride (PVC) and polyurethane (PU) are preferred. Examples of thermoplastic elastomer (TPE) include a thermoplastic olefinic elastomer (TPO) and a thermoplastic ethylenic elastomer. As the polyurethane (PU), an ether-based polyurethane is preferred.

The moisture permeability of the sealing member 40 at a temperature of 40° C. and a humidity of 90% RH is preferably 1.0 g/m²·day or lower, more preferably 0.5 g/m²·day or lower, still more preferably 0.1 g/m²·day or lower.

The laminated glass 100 is provided with a light blocking part 50. The light blocking part 50 is preferably provided on a peripheral edge portion of the laminated glass 100. The light blocking part 50 is a frame-shaped region having a predetermined width, and blocks at least visible light (with wavelengths of 380 nm to 780 nm). The blocking is performed by e.g. absorbing light to be blocked. The visible light transmittance of the light blocking part 50 is, for example, 5% or lower, preferably 3% or lower, more preferably 1% or lower, still more preferably substantially 0%. The light blocking part 50 preferably further blocks ultraviolet light (with wavelengths of 300 nm to 380 nm), and preferably further blocks infrared light (with wavelengths of 780 nm to 2,500 nm). The degree of blocking may vary depending on the wavelength of light.

The light blocking part 50 is provided in the form of a substantially opaque layer (for example, first and second light blocking layers as will be described later), but can be provided in any form as long as it can block visible light to a degree that allows concealment in at least a region where concealment is required. For example, the light blocking part 50 may be formed of an organic ink, a colored ceramic material, a colored film or the like. The color of the light blocking part 50 can be any color such as black, brown or dark navy, but is preferably a dark color, more preferably black.

The light blocking part 50 is preferably arranged to overlap the peripheral edge portion of the functional layer 30 in plan view. This arrangement leads to a reduced amount of light incident on the peripheral edge portion of the functional layer 30 so that it becomes easy to suppress deterioration of the functional layer 30 that progresses from its peripheral edge portion. Particularly in the case where the functional layer 30 contains liquid crystal, it becomes easy to suppress deterioration of the functional layer 30 by blocking of e.g. ultraviolet light.

FIG. 2 is a cross-sectional view (hereinafter also referred to as a “X₁-X₂ cross-sectional view”) of the laminated glass 100 of the first embodiment, as taken along the XZ plane at position X₁-X₂ of FIG. 1 and as viewed from the Y-axis direction.

The first glass plate 11 has a first main surface 11a, a second main surface 11b and a first end surface 11e. The first end surface 11e is a surface connecting the first main surface 11a and the second main surface 11b, and constitutes the peripheral edge of the first glass plate 11. The second glass plate 12 has a third main surface 12a, a fourth main surface 12b and a second end surface 12e. The second end surface 12e is a surface connecting the third main surface 12a and the fourth main surface 12b, and constitutes the peripheral edge of the second glass plate 12.

Although the first and second glass plates 11 and 12 may be flat plate-shaped, it is preferable that at least one of the first and second glass plates is curved in shape. It is more preferable that both of the first and second glass plates are curved in shape. Each of the first glass plate 11 and the second glass plate 12 may have a single curved (cylindrical) shape curved only in one direction or may have a complex curved shape curved in two mutually perpendicular directions.

In the first embodiment illustrated in FIGS. 1 and 2, the laminated glass 100 has a curved shape where at least the first and second glass plates 11 and 12 are curved in the thickness direction (Z-axis direction). More specifically, the first main surface 11a and the third main surface 12a are formed as convex surfaces; and the second main surface 11b and the fourth main surface 12b are formed as concave surfaces. The second main surface 11b and the third main surface 12a face each other. In the case where the first and second glass plates 11 and 12 are curved in shape as described above, it is preferable that the concave surface of the first glass plate 11 and the convex surface of the second glass plate 12 face each other. It is further preferable that, when the laminated glass is installed in a vehicle, the first glass plate 11 is to be located on the vehicle exterior side and the second glass plate 12 is to be located on the vehicle interior side.

The thicknesses of the first and second glass plates 11 and 12 can be selected as appropriate depending on the type and part etc. of a vehicle in which the laminated glass 100 is to be installed. In general, each of the first and second glass plates has a thickness of 0.1 mm to 10 mm. In the following, the thicknesses of the first and second glass plates 11 and 12 will be described for the case where the laminated glass 100 is installed in a vehicle with the first glass plate 11 located on the vehicle exterior side and the second glass plate 12 located on the vehicle interior side. It is herein noted that, when the glass plate has a thickness distribution, the thickness of the thinnest portion of the glass plate is taken as the thickness of the glass plate.

The thickness of the first glass plate 11 is preferably 0.3 mm or larger, more preferably 0.5 mm or larger, still more preferably 0.7 mm or larger, particularly preferably 1.1 mm or larger, most preferably 1.6 mm or larger, in terms of flying stone impact resistance. The thickness of the first glass plate 11 is preferably 3 mm or smaller, more preferably 2.6 mm or smaller, still more preferably 2.1 mm or smaller, to suppress an increase in the mass of the laminated glass 100.

The same thickness range as the first glass plate 11 applies to the second glass plate 12. The second glass plate 12 may be different in composition from the first glass plate 11. Furthermore, the second glass plate 12 may be different in thickness from the first glass plate 11.

In the case where the first glass plate 11 and the second glass plate 12 are different in thickness, it is preferable that the glass plate to be located on the vehicle exterior side has a thickness larger than that of the glass plate to be located on the vehicle interior side in terms of flying stone impact resistance. A difference between the thickness of the first glass plate 11 and the thickness of the second glass plate 12 is preferably from 0.3 mm to 1.5 mm, more preferably from 0.5 mm to 1.3 mm.

A coating may be provided to impart a water-repellent function, a hydrophilic function, an antifouling function, an anti-fingerprint function, an antifogging function, an electric heating function, an infrared absorbing/cutting function, an ultraviolet absorbing/cutting function, low emissivity characteristics, low reflective characteristics, coloring etc. to the main surface of at least one of the first and second glass plates 11 and 12. Coatings with these functions may be used solely or in combination of two or more thereof. In place of such a coating, a film having the same function or characteristics may be adhered to the main surface of the glass plate.

The adhesive interlayer 20 is arranged in contact with the second main surface 11b and the third main surface 12a to bond the first glass plate 11 and the second glass plate 12 together. The adhesive interlayer 20 is in contact with the entire second and third main surfaces 11b and 12a in FIG. 2, but may be partially not in contact with at least one of the second and third main surfaces 11b and 12a as in the later-described modified examples. Furthermore, the adhesive interlayer 20 is in contact with both main surfaces and end surface of the functional layer 30. In other words, the functional layer 30 is encapsulated within the adhesive interlayer 20. The encapsulated functional layer 30 may be curved in the thickness direction (Z-axis direction) or may not be curved.

The adhesive interlayer 20 may be a so-called sound insulation interlayer film to enhance the sound insulation performance of laminated glass by sufficient shear deformation. As an example of the sound insulation interlayer film, known is a multilayer film having at least three alternating layers of PVB resin with a glass transition temperature of 15° C. or higher and PVB resin with a glass transition temperature of lower than 15° C.

In a region where the adhesive interlayer 20 overlaps the functional layer 30 in plan view, the thickness of the adhesive interlayer 20 refers to the thickness of the adhesive interlayer itself except the functional layer 30. In the case where the adhesive interlayer has a plurality of layers, the thickness of the adhesive interlayer refers to the total thickness of the layers. The thinnest portion of the adhesive interlayer 20 may be a portion of the adhesive interlayer that overlaps the functional layer 30 in plan view. The thickest portion of the adhesive interlayer 20 may be a portion of the adhesive interlayer that does not overlap the functional layer 30 in plan view.

The thickness of the thinnest portion of the adhesive interlayer 20 is preferably 0.5 mm or larger. When the thickness of the thinnest portion of the adhesive interlayer 20 is 0.5 mm or larger, the laminated glass 100 can ensure required impact resistance. In terms of sound insulation, the thickness of the thinnest portion of the adhesive interlayer is preferably 0.8 mm or larger, more preferably 1.0 mm or larger, still more preferably 1.53 mm or larger, further more preferably 2.0 mm or larger. The thickness of the thickest portion of the adhesive interlayer 20 is preferably 4.0 mm or smaller. When the thickness of the thickest portion of the adhesive interlayer 20 is 4.0 mm or smaller, the mass of the laminated glass 100 will not become too large. The thickness of the thickest portion of the adhesive interlayer 20 may be 3.1 mm or smaller, may be 2.8 mm or smaller, or may be 2.6 mm or smaller.

In the first embodiment, the sealing member 40 has a base portion 40b that extends between planes respectively including (extensions of) the first and fourth main surfaces 11a and 12b and does not overlap the first and second glass plates 11 and 12 in plan view.

The sealing member 40 is in contact with the first end surface 11e and the second end surface 12e. It is preferable that the sealing member 40 is in contact with the first and second end surfaces 11e and 12e around the entire peripheries of the first and second glass plates 11 and 12. The sealing member 40 is also in contact with the adhesive interlayer 20. The width of the sealing member 40, that is, the dimension of the sealing member in the X-axis direction in FIG. 2 is preferably 0.5 mm or larger, more preferably 0.8 mm or larger, still more preferably 1 mm or larger, further more preferably 2 mm or larger. The upper limit of the width of the sealing member 40 is not particularly limited as long as it does not interfere with the installation of the laminated glass 100 in a vehicle. In the case where the width of the sealing member 40 varies depending on the position, it is preferable that the minimum value of the width of the sealing member 40 meets the above-described range.

The sealing member 40 and the functional layer 30 are preferably arranged apart from each other. A distance d between (an inner edge of) the base portion 40b of the sealing member 40 and the functional layer 30 is preferably 1 mm or more, more preferably 2 mm or more, still more preferably 3 mm or more. By arranging the sealing member 40 and the functional layer 30 apart from each other, the functional layer 30 can be protected from pressure, impact and heat etc. that may be caused during the formation of the sealing member 40 and during the use of the laminated glass 100. The reduction of heat applied to the functional layer 30 is particularly effective in suppressing deterioration of the functional layer 30.

The laminated glass may have an adhesion layer (not shown) between the sealing member 40 and the glass plate and/or between the sealing member 40 and the adhesive interlayer 20. In particular, the laminated glass preferably has an adhesion layer between the sealing member 40 and the first end surface 11e and between the sealing member 40 and the second end surface 12e. The adhesion layer serves to firmly hold the sealing member 40 in the laminated glass 100.

The adhesion layer is formed of, for example, a resin adhesive. Examples of the resin adhesive include a urethane resin, an olefin resin, a phenolic resin, an acrylic resin, an epoxy resin, a silicone resin and a silane resin. The adhesion layer preferably contains a silane coupling agent such as epoxy silane.

The thickness of the adhesion layer is, for example, from 0.5 μm to 50 μm. The thickness of the adhesion layer is preferably 1 μm or larger, more preferably 3 μm or larger, still more preferably 5 μm or larger. The adhesion layer, when not too small in thickness, can easily ensure adhesion. Further, the thickness of the adhesion layer is preferably 20 μm or smaller, more preferably 15 μm or smaller. The adhesion layer, when not too large in thickness, can easily ensure sealing properties. The thickness range of the adhesion layer includes a combination of the above-described values, and is preferably 3 μm to 20 μm, more preferably 5 μm to 15 μm. When the thickness of the adhesion layer is in this range, it is easy to prevent the entry of water.

In the first embodiment, the whole of the sealing member 40 is configured as the base portion 40b. In other words, there is no step between the sealing member 40 and the first main surface 11a so that water droplets would not be trapped in a step portion. This makes it less likely that moisture will penetrate through the interface between the sealing member 40 and the first glass plate 11 and thereby makes it easy to prevent an increase of the water content in the adhesive interlayer 20. Further, the presence of no step leads to excellent aesthetics. The same applies to the configuration between the sealing member 40 and the fourth main surface 12b.

In the illustrated example of FIG. 2, the light blocking part 50 includes a first light blocking layer 51 and a second light blocking layer 52. The first light blocking layer 51 is provided on the second main surface 11b of the first glass plate 11. The second light blocking layer 52 is provided on the fourth main surface 12b of the second glass plate 12. These light blocking layers make it less likely that the peripheral edge portion of the functional layer 30 will be irradiated with direct sunlight or reflection light from the constituent members of the laminated glass 100. It is thus effective in suppressing deterioration of the functional layer 30. The light blocking part 50 can be formed by at least one of the first light blocking layer 51 and the second light blocking layer 52. The light blocking part 50 may be formed by providing a light blocking layer on a surface of or inside the adhesive interlayer 20. The formation of the light blocking part 50 is not essential and may be omitted.

The thickness of the first light blocking layer 51 is not particularly limited and is, for example, in the range of 1 μm to 200 μm, preferably 5 μm to 150 μm. In the case where the first light blocking layer 51 is formed of an organic ink or a colored ceramic material, the thickness of the first light blocking layer 51 is more preferably in the range of 5 μm to 30 μm. The same applies to the thickness of the second light blocking layer 52.

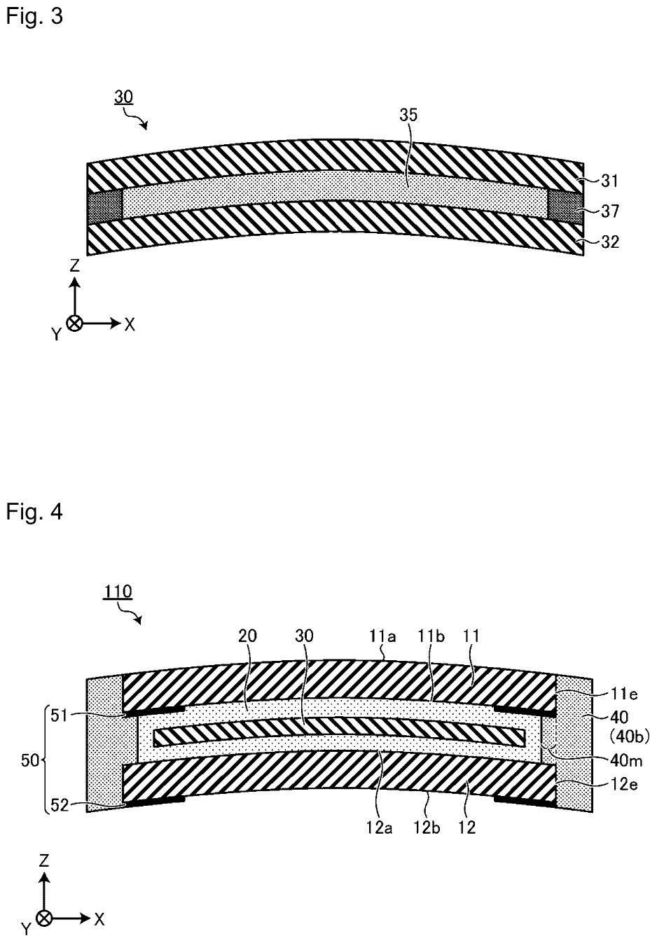

FIG. 3 is a cross-sectional view (X₁-X₂ cross-sectional view) illustrating one configuration example of the functional layer 30. Here, the functional layer 30 is illustrated as being formed of a light control film. The functional layer 30 has a first base material 31, a second base material 32, an active layer 35 and a barrier material 37. The first base material 31 and the second base material 32 are arranged with main surfaces thereof facing each other. The active layer 35 is arranged between the first base material 31 and the second base material 32. The first base material 31 and the second base material 32 are preferably sheet-shaped dielectric bodies made of a transparent material, and preferably has flexibility.

The barrier material 37 is arranged around (an end surface of) the active layer 35. The barrier material 37 has the function of preventing the entry of moisture etc. into the active layer 35. The barrier material 37, which is in contact with the adhesive interlayer 20, preferably has the function of preventing the entry of a plasticizer from the adhesive interlayer 20 into the active layer 35.

Examples of the barrier material 37 include: film materials of polyethylene terephthalate (PET), polyimide (PI), polyethylene (PE), polyamide (PA), polyvinyl fluoride (PVF) and the like; and those formed by using these film materials as base materials and applying pressure sensitive adhesives to surfaces of the base materials. The barrier material 37 may be a thermosetting resin such as an epoxy resin or an acrylic resin. The thickness of the barrier material 37 is, for example, from 20 μm to 300 μm. To minimize the occurrence of local thickness deviations in the functional layer 30, the thickness of the barrier material 37 is preferably 200 μm or smaller, more preferably 100 μm or smaller, still more preferably 50 μm or smaller.

It is preferable that the sealing member 40 and the barrier material 37 are made of different materials. By the combined use of the sealing member 40 and the barrier material 37, deterioration of the functional layer 30 (active layer 35) can be effectively suppressed. The barrier material 37 is located between the first base material 31 and the second base material 32 in the example of FIG. 3, but is not limited to such a positional relationship. The barrier material 37 may be provided as needed.

Transparent conductive films (not shown) are formed on main surfaces of the first and second base materials 31 and 32 in contact with or adjacent to the active layer 35. The active layer 35 is driven with the application of a voltage between the transparent conductive films.

### First Modification of First Embodiment

FIG. 4 is a cross-sectional view of a laminated glass 110 according to the first modification of the first embodiment. This modification will be described below focusing on the differences from the laminated glass 100, and the description of the first embodiment applies to this modification except for those differences. This modification is different from the first embodiment in that: the adhesive interlayer 20 is partially not in contact with the first glass plate 11 and the second glass plate 12; and the sealing member 40 has an intermediate protruding portion 40m protruding toward the adhesive interlayer 20.

The intermediate protruding portion 40m is a portion of the sealing member 40 located between the first glass plate 11 and the second glass plate 12, and is formed integrally (continuously) with the base portion 40b.

The peripheral edge of the adhesive interlayer 20 is located more inward than the peripheral edges of the first and second glass plates 11 and 12. In other words, at least parts of the peripheral edges of the first and second glass plates 11 and 12 are not in contact with the adhesive interlayer 20.

A clearance distance between the peripheral edge of the adhesive interlayer 20 and the peripheral edges of the first and second glass plates 11 and 12 is, for example, from 0.2 mm to 2.0 mm. The clearance distance is preferably 0.3 mm or more, more preferably 0.4 mm or more. When the clearance distance is more than or equal to this lower limit value, it is easy to achieve improved sealing properties of the sealing member 40. The clearance distance is preferably 1.0 mm or less, more preferably 0.8 mm or less, still more preferably 0.7 mm or less. When the clearance distance is less than or equal to this upper limit value, it is easy to suppress strength decrease in the peripheral edge portion of the laminated glass 110. As a preferred combination of the upper and lower limit values, the clearance distance may be in the range of, for example, from 0.2 mm to 0.8 mm, but is not limited to this range.

In the case where one of the first glass plate 11 and the second glass plate 12 is located more inward than the other glass plate, the clearance distance can be determined as a distance from the peripheral edge of the more inward located glass plate to the peripheral edge of the adhesive interlayer 20.

In this modification, since the sealing member 40 is provided with the intermediate protruding portion 40m, the inner edge of the sealing member 40 is located more inward than the peripheral edges of the first and second glass plates 11 and 12. Furthermore, the intermediate protruding portion 40m of the sealing member 40 is in contact with the second and third main surfaces 11b and 12a. The amount (width) of protrusion of the intermediate protruding portion 40m is, for example, 0.2 mm to 2.0 mm, and preferably matches with the above-described clearance distance. When the protrusion amount of the intermediate protruding portion 40m matches with the clearance distance, it is easy to achieve both of improved sealing properties of the sealing member 40 and less strength decrease in the peripheral edge portion of the laminated glass 110.

### Second Embodiment

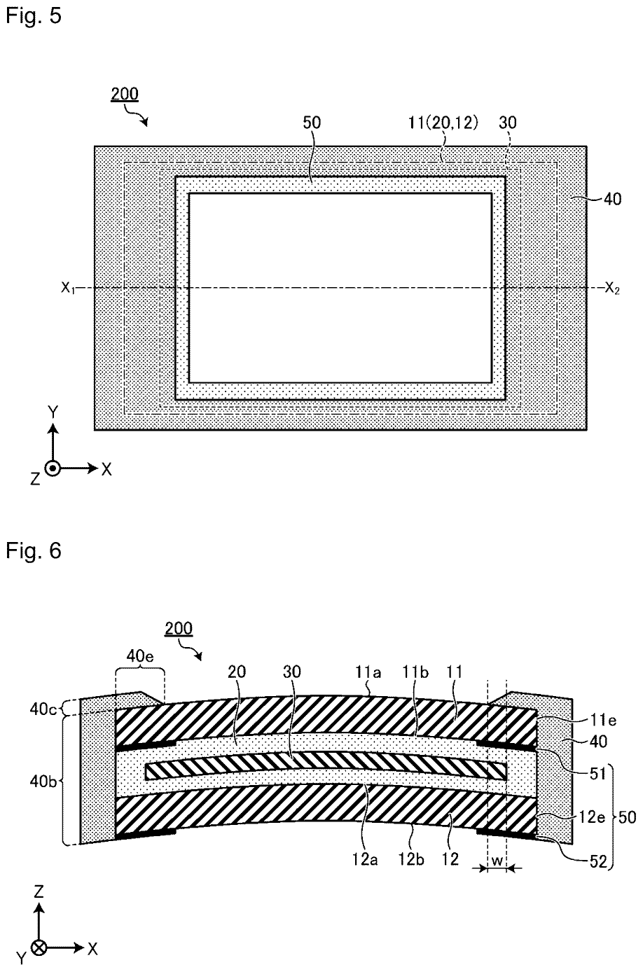

FIG. 5 is a plan view of a laminated glass 200 according to the second embodiment. Here, peripheral edges of first and second glass plates 11 and 12 and the adhesive interlayer 20 are indicated by a dash-dotted line; and a peripheral edge of the functional layer 30 is indicated by a dotted line. The second embodiment will be described below focusing on the differences from the laminated glass 100 of the first embodiment, and the description of the first embodiment applies to the second embodiment except for those differences. The second embodiment is different from the first embodiment in that: a part of the sealing member 40 is located more outward than the first and second glass plates 11 and 12; and a part of the sealing member 40 overlaps at least one of the first and second glass plates 11 and 12. By such a configuration, various functions can be realized.

In FIG. 5, the sealing member 40 partially overlaps the first and second glass plates 11 and 12. More specifically, the sealing member partially overlaps the peripheral edge portion of at least one of the first and second glass plates 11 and 12 around the entire periphery of the laminated glass 200. It can be said that the sealing member 40 is preferably in contact with at least one of the first main surface 11a and the fourth main surface 12b. Accordingly, the inner edge of the sealing member 40 is located more inward than the first and second glass plates 11 and 12 in plan view. More specifically, the sealing member 40 is arranged continuously from a point outward of the first glass plate 11 to the main surface of the first glass plate 11 in plan view.

In plan view, the ratio of an area of overlap between the sealing member 40 and the glass plate (for example, the first glass plate 11) to an area of the glass plate is preferably 50% or less, more preferably 40% or less, still more preferably 30% or less. When the overlap area ratio is in this range, the window opening will not become too narrow. The lower limit of the overlap area ratio is, for example, 1% or more, but is not limited to this.

In FIG. 5, the width of the sealing member 40 on the top and bottom sides of the laminated glass 200 differs from that on the left and right sides of the laminated glass. However, the width of the sealing member may be substantially uniform throughout its entire periphery, or the width of the sealing member on at least one side may differ from those on the other sides. The width of the sealing member 40 may vary from part to part on a given side.

The inner edge of the sealing member 40 (the innermost side of the later-described protruding end portion) is located more inward than the peripheral edge of the functional layer 30. In other words, the peripheral edge portion of the functional layer 30 overlaps the sealing member 40 in plan view. In this embodiment, the sealing member 40 may have the same function as the light blocking part 50. More specifically, the sealing member 40 may block at least visible light and may block visible light and ultraviolet light. The sealing member 40 may block infrared light in addition to the above light. This light blocking function of the sealing member 40 leads to a reduced amount of light incident on the peripheral edge portion of the functional layer 30 so that it becomes easy to suppress deterioration of the functional layer 30 that progresses from its peripheral edge portion.

In the case where the sealing member 40 is formed by injection molding or integral extrusion molding, a region of the laminated glass located more inward than the inner edge of the sealing member 40 is held by a mold in the process of producing the laminated glass 200. Accordingly, load is exerted on the functional layer 30. If the peripheral edge portion of the functional layer 30 is located to overlap the region held by the mold in plan view, the functional layer 30 may be damaged. In the case of FIG. 3, for example, the active layer 35 may peel off from the first base material 31 or the second base material 32 and lose its function. Particularly when the functional layer 30 contains liquid crystal, the layer containing liquid crystal may peel off from the base material.

However, when the peripheral edge of the functional layer 30 is located to overlap the sealing member 40 in plan view, the peripheral edge portion of the functional layer 30 is less susceptible to pressure from the mold so that damage to the functional layer 30 can be suppressed.

The sealing member 40 may be substantially transparent. The expression “substantially transparent” does not necessarily mean colorless and can mean being colored with a visible light transmittance of 80% or higher, more preferably 90% or higher. For example, at least a portion of the sealing member 40 overlapping the glass plates may have a visible light transmittance of 80% or higher.

The sealing member 40 may be substantially opaque. The expression “substantially opaque” as used herein means having a visible light transmittance of 3% or lower, more preferably 1% or lower, still more preferably lower than 1%. In the case where the sealing member 40 is colored, the color of the sealing member is preferably a dark color such as black, navy or brown, more preferably black.

In the case where the sealing member 40 is substantially transparent or dark in color, the sealing member 40 can easily harmonize in color with the light blocking part 50 to achieve excellent aesthetics. In the case where the sealing member 40 is dark in color, it is easy to reduce the amount of light incident on the peripheral edge portion of the functional layer 30 over a broad wavelength range.

The second embodiment may be combined with the first embodiment. For example, the sealing member 40 may overlap at least one of the first and second glass plates 11 and 12 on one side of the laminated glass 200 and not overlap either the first glass plate 11 or the second glass plate 12 on the other sides of the laminated glass 200. One example of the configuration in which the sealing member does not overlap either the first glass plate 11 or the second glass plate 12 is that described in the first embodiment.

FIG. 6 is an X₁-X₂ cross-sectional view of the laminated glass 200 of the second embodiment. The sealing member 40 has a protruding end portion 40e and a connection portion 40c in addition to the base portion 40b.

The protruding end portion 40e is a portion of the sealing member 40 positioned in the plus Z-axis direction with respect to the first main surface 11a or in the minus Z-axis direction with respect to the fourth main surface 12b. In the laminated glass 200, the protruding end portion 40e protrudes inward from the peripheral edge of the first glass plate 11 and lies in contact with the first main surface 11a. The connection portion 40c is a portion of the sealing member connecting the base portion 40b and the protruding end portion 40e. The base portion 40b, the connection portion 40c and the protruding end portion 40e are formed as one piece (continuously) and are preferably made of the same material. The sealing member 40 is also in contact with the adhesive interlayer 20.

In the second embodiment, it is possible by providing the sealing member 40 with the protruding end portion 40e to suppress peeling of the base portion 40b from the first end surface 11e and easily maintain waterproofing properties over a long term. The amount of protrusion of the protruding end portion 40e is preferably 2 mm or more, more preferably 3 mm or more, still more preferably 4 mm or more, further more preferably 5 mm or more. It is preferable that the amount of protrusion of the protruding end portion 40e is greater than the distance d between the base portion 40b and the functional layer 30. The amount of protrusion of the protruding end portion 40e may be, for example, 50 mm or less, 30 mm or less, or 20 mm or less.

The width of overlap between the sealing member 40 and the functional layer 30 in plan view is preferably 1 mm or more, more preferably 2 mm or more, still more preferably 3 mm or more. In other words, it is preferable that the protruding end portion 40e overlaps the peripheral edge of the functional layer 30 in plan view. The width of overlap between the sealing member 40 and the functional layer 30 in plan view may be, for example, 49 mm or less, 40 mm or less, 30 mm or less, 20 mm or less, or 10 mm or less. The smaller the width of overlap between the sealing member 40 and the functional layer 30, the larger the region where the functional layer 30 is visible.

When the peripheral edge of the functional layer 30 is located to overlap the sealing member 40 in plan view, the peripheral edge portion of the functional layer 30 is less susceptible to pressure from the mold so that damage to the functional layer 30 can be suppressed.

It is preferable that the thickness (Z-axis direction length) of the protruding end portion 40e is smaller than the width (X-axis direction length) of the base portion 40b. The thickness of the protruding end portion 40e is preferably smaller than 2 mm, more preferably smaller than 1 mm, still more preferably smaller than 0.8 mm, further more preferably smaller than 0.5 mm. Further, the thickness of the protruding end portion 40e is preferably 0.1 mm or larger, more preferably 0.2 mm or larger, still more preferably 1 mm or larger, further more preferably 2 mm or larger. When the thickness of the protruding end portion 40e is 0.1 mm or larger, the sealing member 40 is less prone to breakage.

In the example of FIG. 6, the protruding end portion 40e has a slope such that the thickness decreases inward of the first glass plate 11. This leads to a smaller step between the sealing member 40 and the first main surface 11a to suppress the trapping of water in the step. This also suppresses peeling of the protruding end portion 40e. The slope does not need to be formed over the entire protruding end portion 40e as shown in FIG. 6, and may be formed to start from an inner edge of the protruding end portion 40e. It suffices that at least the slope that increases in thickness outward (toward the connection portion 40c) starts from the inner edge of the protruding end portion 40e.

The adhesion layer may be provided between the protruding end portion 40e and the first glass plate 11, more specifically between the protruding end portion 40e and the first main surface 11a.

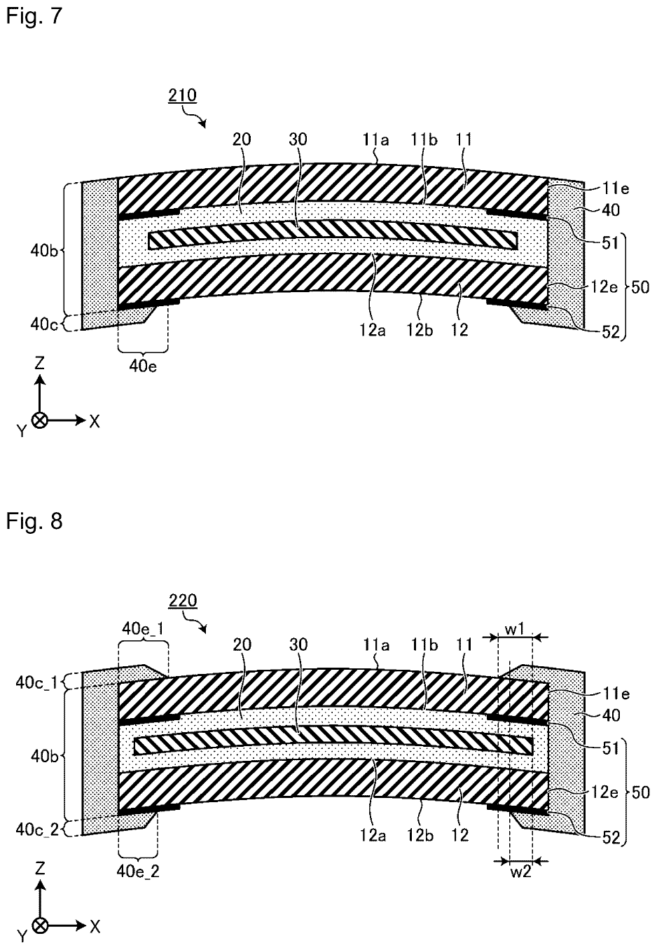

FIG. 7 is an X₁-X₂ cross-sectional view of a laminated glass 210 according to the first modification of the second embodiment. This modification will be described below focusing on the differences from the laminated glass 200 of the second embodiment, and the description of the second embodiment applies to this modification except for those differences. The laminated glass of this modification is different from the laminated glass 200 of the second embodiment in that the protruding end portion 40e of the sealing member 40 protrudes inward from the peripheral edge of the second glass plate 12 and lies in contact with the fourth main surface 12b.

In this modification, there is no step between the sealing member 40 and the first main surface 11a so that water droplets would not be trapped in a step portion. This makes it less likely that moisture will penetrate the interface between the sealing member and the first glass plate 11 and thereby makes it easy to prevent an increase of the water content in the adhesive interlayer 20. Further, the presence of no step leads to excellent aesthetics.

Further, it is possible in this modification to attach the laminated glass 210 to a vehicle body frame (window frame) without direct contact therebetween, thereby making it easy to prevent the base portion 40b and the second end surface 12e from separation and damage. It is also possible to, when water droplets form on the fourth main surface 12b due to condensation, easily suppress penetration of such water droplets into the adhesive interlayer 20 by the protruding end portion 40e.

Even in this modification, the peripheral edge portion of the functional layer 30 is preferably located to overlap the sealing member 40 in plan view. In other words, it is preferable that the protruding end portion 40e overlaps the peripheral edge of the functional layer 30 in plan view. In the case where the sealing member 40 is formed by injection molding or integral extrusion molding, damage to the functional layer 30 can be suppressed.

The adhesion layer may be provided between the protruding end portion 40e and the second glass plate 12, more specifically between the protruding end portion 40e and the fourth main surface 12b.

FIG. 8 is an X₁-X₂ cross-sectional view of a laminated glass 220 according to the second modification of the second embodiment. This modification will be described below focusing on the differences from the second embodiment, and the description of the second embodiment applies to this modification except for those differences. The laminated glass of this modification is different from the laminated glass 200 of the second embodiment in that: the sealing member 40 has protruding end portions 40e_1 and 40e_2 and connection portions 40c_1 and 40c_2 so as to protrude inward from the peripheral edges of the first and second glass plates 11 and 12 and lie in contact with the first and fourth main surfaces 11a and 12b, respectively.

The positions of inner edges of the protruding end portion 40e on the first glass plate 11 side and the second glass plate 12 side may be the same or different. In the example of FIG. 8, the inner edge of the protruding end portion 40e on the first glass plate 11 side (i.e. the inner edge of the protruding end portion 40e_1) is located more outward than the inner edge of the protruding end portion 40e on the second glass plate 12 side (i.e. the inner edge of the protruding end portion 40e_2). In other words, in plan view, a distance w1 from the peripheral edge of the functional layer 30 to the first glass plate 11-side inner edge of the sealing member 40 is greater than a distance w2 from the peripheral edge of the functional layer 30 to the second glass plate 12-side inner edge of the sealing member 40. In this configuration, the peripheral edge portion of the functional layer 30 can be effectively protected from various light radiations, and the apparent opening area visible to vehicle occupants (the area of the region where the fourth main surface 12b and the sealing member 40 do not overlap each other) can be increased.

Even in this modification, the peripheral edge portion of the functional layer 30 is preferably located to overlap the sealing member 40 in plan view. In other words, it is preferable that the protruding end portions 40e_1 and 40e_2 overlap the peripheral edge of the functional layer 30 in plan view.

### (Laminated Glass Production Method According to Embodiment of Present Invention)

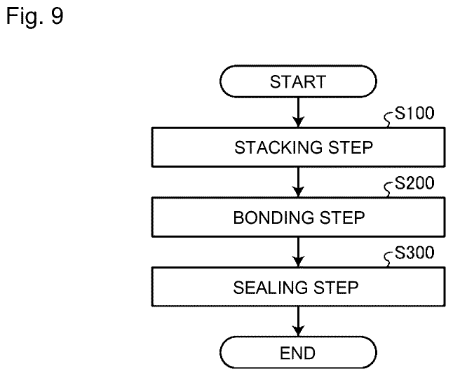

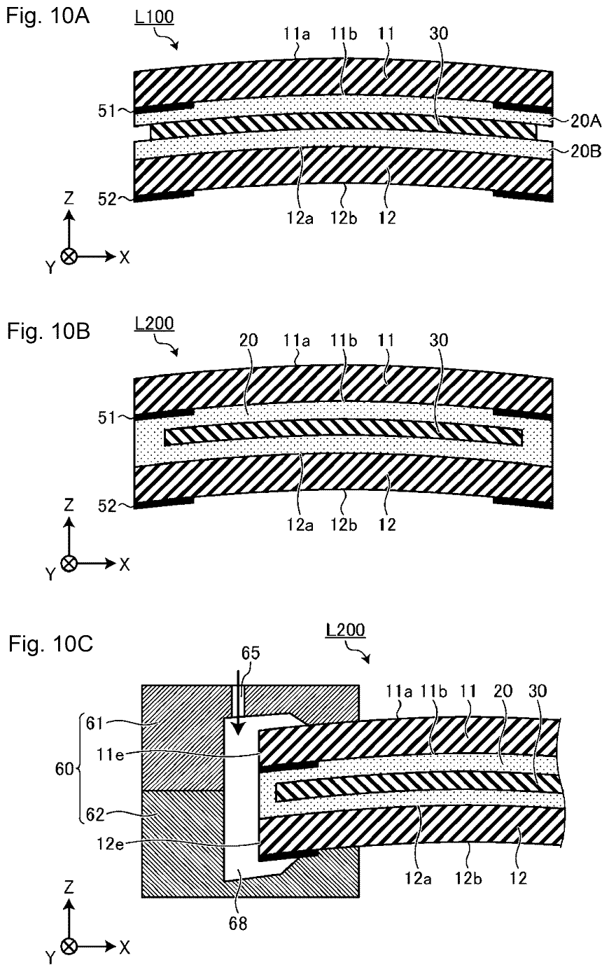

Next, an example of a method for producing a laminated glass will be described below with reference to FIGS. 9 and 10A to 10C. FIG. 9 is a flowchart of the method for producing a laminated glass. FIGS. 10A to 10C are schematic views illustrating the method for producing the laminated glass 220. The method for producing a laminated glass generally includes a stacking step (S100), a bonding step (S200) and a sealing step (S300).

The stacking step (S100) is a step of preparing a layered body L100 in which the first glass plate 11, a resin sheet 20A, the functional layer 30, a resin sheet 20B and the second glass plate 12 are stacked in this order as shown in FIG. 10A.

The resin sheets 20A and 20B are sheets to be formed into the adhesive interlayer of the laminated glass 220 in the bonding step (S200) as will be described later. An additional resin sheet may be provided in addition to the resin sheets 20A and 20B. For example, the additional resin sheet may have a frame-like shape (frame shape) to surround the outer side of the functional layer 30.

For the production of a curved laminated glass such as the laminated glass 220, at least one of the first glass plate 11 and the second glass plate 12 is bent into a curved shape in advance. In the examples of FIGS. 10A to 10C, both of the first glass plate 11 and the second glass plate 12 are bent into a curved shape. Although the first and second light blocking layers 51 and 52 are respectively formed on the concave surfaces of the first and second glass plates 11 and 12, i.e., on the second and fourth main surfaces 11b and 12b, the formation positions of the first and second light blocking layers 51 and 52 are not limited to such positions. For example, the first light blocking layer 51 may be formed on the resin sheet 20A, and the second light blocking layer 52 may be formed on the resin sheet 20B.

Here, the stacking procedure is not particularly limited. The stacking may be performed sequentially from the first glass plate 11 side or may be performed sequentially from the second glass plate 12 side. The stacking may be performed by, for example, forming a stack of the resin sheet 20A, the functional layer 30 and the resin sheet 20B and then sandwiching the stack between the first glass plate 11 and the second glass plate 12.

The bonding step (S200) is a step of forming the resin sheets into the adhesive interlayer 20 between the first glass plate 11 and the second glass plate 12 such that the adhesive interlayer is in contact with the second and third main surfaces 11b and 12a to bond the glass plates together. The layered body L100 prepared in the stacking step (S100) is placed in a rubber bag and subjected to primary pressure bonding under controlled conditions of a temperature of 100° C. to 140° C. and an absolute pressure of 0.01 MPa to 0.1 MPa within the bag. The pressure applied within the rubber bag during the primary pressure bonding can be caused by, for example, sucking air out of the bag. After that, the layered body is subjected to secondary pressure bonding in an autoclave under controlled conditions of a temperature of 120° C. to 140° C. and an absolute pressure of 0.5 MPa to 1.4 MPa. Thus obtained is a layered body L200 in which the prescribed adhesive interlayer 20 has been formed as shown in FIG. 10B.

The temperature and pressure conditions in the bonding step (S200) can be adjusted as appropriate according to the types etc. of the resin sheets in the layered body L100. For example, in the case where the resin sheets 20A and 20B are made of EVA, only the primary pressure bonding may be performed without the secondary pressure bonding. A rubber channel or the like may be used in place of the rubber bag.

Furthermore, the bonding step (S200) may include removing a part of the adhesive interlayer 20 of the layered body L200. For example, a side surface (end surface) of the adhesive interlayer 20 may be removed continuously around the entire periphery. In other words, the end surface of the adhesive interlayer 20 may be formed into an inward concave shape. The removal of the adhesive interlayer 20 can be performed by means of a cutter or the like.

The sealing step (S300) is a step of forming the sealing member from the resin material such that the sealing member is in contact with at least the first and second end surfaces 11e and 12e. The sealing member can be formed by, for example, injection molding. The following description will be given of injection molding. First, a peripheral edge portion of the layered body L200 is held by a mold 60. More specifically, the layered body L200 is held between first and second mold parts 61 and 62 in the thickness direction (Z-axis direction), followed by clamping these mold parts to define a cavity 68. The cavity 68 is a space defined by the first and second mold parts 61 and 62 and the layered body L200, and has substantially the same shape as the shape of the sealing member in the laminated glass product.

An elastic material such as a tape or a rubber may be provided on a contact area of the mold 60 with the glass plates or embedded in the mold 60. This allows the glass plates to be held softly, thereby suppressing breakage of the glass plates.

In the case where the mold 60 is shaped so as not to contact at least one of the peripheral edges of the first and second glass plates 11 and 12, that is, in the case where the cavity 68 is defined including at least one of the first and fourth main surfaces 11a and 12b, the pressure exerted by being held by the mold 60 is concentrated on the inner region of the layered body L200 rather than its peripheral edge. In such a case, it is preferable that the mold 60 holds the layered body L200 in such a manner that the contact area of the mold with at least one of the first and fourth main surfaces 11a and 12b does not overlap the peripheral edge of the functional layer 30 in plan view. In other words, it is preferable that, in plan view, the peripheral edge of the functional layer 30 is located more inward or outward than the region overlapping the contact area of the mold 60 with the first and fourth main surfaces 11a and 12b. By holding the layered body L200 in such a manner, damage to the functional layer 30 can be suppressed.

When the peripheral edge of the functional layer 30 is located more inward than the region overlapping the contact area of the mold 60 with at least one of the first and fourth main surfaces 11a and 12b in plan view, the sealing member can exert a significant effect of protecting the functional layer 30 from moisture etc. It is also easy to deal with the functional layer 30 having a larger area. In the example shown in FIG. 10C, the peripheral edge of the functional layer 30 is located more outward than the region overlapping the contact area of the mold 60 with both the first and fourth main surfaces 11a and 12b in plan view. When the peripheral edge of the functional layer 30 is located more outward than the region overlapping the contact area of the mold 60 with at least one of the first and fourth main surfaces 11a and 12b in plan view, damage to the functional layer 30 can be suppressed by reducing the influence of heat and pressure from the molten resin.

Next, the resin material in a molten state is injected into the cavity 68 through an injection port 65 that is provided in at least one of the first and second molds 61 and 62. As an example, the injection port 65 is provided in the first mold 61 to extend toward the second mold 62. Before the injection of the molten resin material into the cavity 68, the adhesion layer may be formed on a portion of the layered body L200 with which the molten resin material will come into contact.

The adhesion layer may be formed, for example, on the first end surface 11e and the second end surface 12e. The adhesion layer may additionally be formed on at least one of the first main surface 11a and the fourth main surface 12b. Similarly, the adhesion layer may additionally be provided on the end surface of the adhesive interlayer 20.

After the cavity 68 is filled with the molten resin material injected from the injection port 65, the cavity is held at appropriate temperature to cure the molten resin material. The layered body L200 is then removed from the mold 60. More specifically, the first and second molds 61 and 62 are unclamped and separated from each other. With this, the laminated glass 220 shown in FIG. 8 is obtained.

Although the method for producing a laminated glass according to one embodiment of the present invention has been described above taking the production of the laminated glass 220 as an example, the method for producing a laminated glass according to one embodiment of the present invention is not limited to the above-described example. The laminated glass 100, 110, 200, 210 can be produced, for example, using the mold 60 (first and second mold parts 61 and 62) shaped according to the shape of the sealing member in the laminated glass. The sealing member may be separately molded with a mold and fixed by bonding to a predetermined position on the laminated glass.

### EXAMPLES

The present invention will now be described in further detail with reference to Ex. 1 to 5. It should however be understood that the present invention is by no means restricted to these examples.

### Ex. 1

Provided were a 0.7 mm-thick glass plate (vehicle interior side glass plate) and a 2 mm-thick glass plate (vehicle exterior side glass plate) (both commonly known as VFL and manufactured by AGC INC.) to respectively serve as inner and outer plates in a laminated glass. Three 0.38 mm-thick thermoplastic resin sheets (manufactured by SOLUTIA JAPAN LTD., PVB, thickness 0.38 mm) were also provided. Here, the two glass plates had light blocking parts formed by screen printing a black ceramic material on peripheral edge portions thereof and were hot-bent in a desired curved shape in advance.

Further, a light control film in which a 16 μm-thick liquid crystal (PDLC) layer was held between 125 μm-thick PET films with transparent conductive films formed thereon and connected to conductive wires was provided as a functional layer. The outer shape of the light control film (excluding the conductive wires) was approximately 10 mm smaller than those of the glass plates. An end surface (entire periphery) of the light control film was protected with a UV-curable acrylic resin as a barrier material such that the liquid crystal layer was not exposed outside. At this time, the UV-curable acrylic resin was brought in contact with the two PET films and with the liquid crystal layer.

Three thermoplastic resin sheets were provided, one of which was hollowed out into a 10 mm-wide frame shape so as to fit the outer shape of the light control film. Then, the vehicle interior side glass plate, the PVB sheet, the light control film fitted in the frame-shaped PVB sheet, the PVB sheet and the vehicle exterior side glass plate were stacked in this order to obtain an assembly. The assembly was placed in a rubber bag and bonded under vacuum at a gauge pressure of −65 kPa to −100 kPa and a temperature of about 70° C. to 110° C. The assembly was subsequently heated and pressurized under conditions of a temperature of 100° C. to 150° C. and an absolute pressure of 0.6 MPa to 1.3 MPa, thereby obtaining a layered body. In the obtained layered body, the three PVB sheets had been united into one.

Subsequently, a sealing member was formed by injection molding on a peripheral edge portion of the layered body to obtain a laminated glass. More specifically, adhesion layers (Hamatite, manufactured by Sika Japan Ltd.) were first applied with a thickness of 50 μm or smaller to side surfaces and main surfaces of the two glass plates at the peripheral edge portion of the layered body. Next, a portion of the layered body corresponding to a position 6 mm inward from the edge of the light control film was held by a mold (upper and lower mold parts) of predetermined shape. At this time, the mold was not in contact with the peripheral edges of the two glass plates. Then, a cavity formed by the layered body and the mold was filled with a thermoplastic olefinic elastomer in a molten state and slowly cooled. The thus-obtained laminated glass had the structure shown in FIG. 8. The widths of the protruding end portions 40e_1 and 40e_2 were 16 mm, and the width (X-axis direction length) of the base portion 40b was 2 mm.

### Ex. 2

In Ex. 2, a laminated glass having the structure shown in FIG. 8 was produced in the same manner as in Ex. 1 except that polyvinyl chloride was used in place of the thermoplastic olefinic elastomer.

### Ex. 3

In Ex. 3, the same layered body as in Ex. 1 was produced, and a sealing member was formed on the layered body using a different material and different method than in Ex. 1. The sealing member of Ex. 3 was formed by applying a UV-curable acrylic resin (AICAAITRON Z-590VM, manufactured by Aica Kogyo Co., Ltd.) with a thickness of about 50 μm to side surfaces and main surfaces of the two glass plates and a side surface of the integrated PVB layer at a peripheral edge portion of the layered body and curing the acrylic resin. Here, the width of overlap of the sealing member with the surfaces of the two glass plates was 5 mm. With this, a laminated glass having the structure shown in FIG. 8 was obtained.

### Ex. 4

In Ex. 4, the same layered body as in Ex. 1 was produced, and a sealing member was formed on the layered body using a different material and different method than in Ex. 1. The sealing member of Ex. 4 was formed by adhering a tape with an acrylic resin adhesion layer and a polyester base film (No. 31B 75θ, manufactured by Nitto Denko Corporation) in a U-shape to side surfaces and main surfaces of the two glass plates and a side surface of the integrated PVB layer at a peripheral edge portion of the layered body. The total thickness of the tape was 53 μm, the thickness of the base film was 25 μm, and the width of overlap of the sealing member with the two glass plates was 5 mm. With this, a laminated glass having the structure shown in FIG. 8 was obtained.

### Ex. 5

In Ex. 5, a laminated glass having the structure shown in FIG. 8 was produced in the same manner as in Ex. 4 except that the type of the tape was changed to a tape with a silicone resin adhesion layer and a polyimide base film (No. 360UL plastic core type, manufactured by Nitto Denko Corporation). In Ex. 5, the total thickness of the tape was 60 μm, and the thickness of the base film was 25 μm.

### Ex. 6

In Ex. 6, a layered body (laminated glass) was produced in the same manner as in Ex. 1 except that: no barrier material was provided on the end surface (entire periphery) of the light control film; and the layered body was provided with no adhesion layer and no sealing member.

### [Deterioration Evaluation of Functional Layer]

The degree of deterioration of the functional layer (light control film) in each of the laminated glasses of Ex. 1 to Ex. 6 was evaluated. Two sets of samples of the laminated glasses of Ex. 1 to Ex. 6 were prepared, one set immersed in hot water at 40° C. and the other set immersed in hot water at 80° C. The laminated glasses were kept immersed in the hot water for 200 hours. After that, the laminated glasses were taken out of the hot water and dried well. Each of the laminated glasses was connected to a power supply and, with reference to the peripheral edge of the light control film, the width where a certain transmittance change no longer occurred at ON/OFF operations of the power supply (width of deterioration) was measured. Further, the appearance of the sealing member after the drying was observed. The evaluation results of the respective laminated glasses are shown in Table 1. The overall evaluation was rated from the most outstanding Ex. in order of excellent, good, fair and not acceptable.

TABLE 1

| | | Ex. 1 | Ex. 2 | Ex. 3 | Ex. 4 | Ex. 5 | Ex. 6 |
|---|---|---|---|---|---|---|---|
| Sealing member | | Thermoplastic | Polyvinyl | UV- | Resin tape | Resin tape | None |
| | | olefinic | chloride | curable | (Adhesion layer: | (Adhesion layer: | |
| | | elastomer | (PVC) | acrylic | acrylic resin | silicone resin | |
| | | (TPO) | | resin | Base film: | Base film: | |
| | | | | | polyester) | polyimide) | |
| 40° C. | Width of | 0 mm | 0 mm | 0 mm | 1 mm | 1 mm | 3 mm |
| Hot water | deterioration | | | | | | |
| immersion | of light | | | | | | |
| test | control film | | | | | | |
| | Appearance | No peeling | No peeling | No peeling | No peeling | No peeling | — |
| | of sealing | and no | and no | but | but | but | |
| | member | discoloration | discoloration | whitening | discoloration | discoloration | |
| | after test | | | of resin | of tape | of tape | |
| 80° C. | Width of | 0 mm | 0 mm | 0 mm | 3 mm | 6 mm | 8 mm |
| Hot water | deterioration | | | | | | |
| immersion | of light | | | | | | |
| test | control film | | | | | | |
| | Appearance | No peeling | No peeling | No peeling | No peeling | No peeling | — |
| | of sealing | and no | and no | but | but | but | |
| | member | discoloration | discoloration | whitening | discoloration | discoloration | |
| | after test | | | of resin | of tape | of tape | |

| | | | | | | |
|---|---|---|---|---|---|---|
| Overall evaluation | Excellent | Excellent | Good | Fair | Fair | Not |

acceptable

In the laminated glasses of Ex. 1 and Ex. 2, the width of deterioration of the light control film was 0 mm even after immersion in hot water at either 40° C. or 80° C. Further, the sealing member did not peel off from the layered body and was not discolored. It can be said that, in comparison to Ex. 6 in which no sealing member was provided, each of the laminated glasses of Ex. 1 and Ex. 2 had significantly reduced deterioration of the functional member and had excellent durability and aesthetics in high-temperature water environments. The sealing members of Ex. 1 and Ex. 2 were each found to be suitably usable in locations easily visible from inside or outside vehicle (for example, locations overlapping the main surface of the layered body) as well as in other locations.

In the laminated glass of Ex. 3, the width of deterioration of the light control film was 0 mm after immersion in hot water at either 40° C. or 80° C. Although the sealing member did not peel off from the layered body, whitening of the resin was observed after immersion in hot water for 200 hours. It is assumed that the acrylic UV-curable resin absorbed water into its outermost surface, which caused changes to its surface condition and resulted in whitening. However, the cause of the whitening of the resin is not limited to this. From these results, it can be said that the laminated glass of Ex. 3 had significantly reduced deterioration of the functional member in comparison to Ex. 6 in which no sealing member was provided. It can also be said that this laminated glass had a certain level of durability and aesthetics even in high-temperature water environments.

In the laminated glass of Ex. 4, the width of deterioration of the light control film was 1 mm after immersion in hot water at 40° C. and was 3 mm after immersion in hot water at 80° C. In the laminated glass of Ex. 5, the width of deterioration of the light control film was 1 mm after immersion in hot water at 40° C. and was 6 mm after immersion in hot water at 80° C. In each of Ex. 4 and Ex. 5, discoloration of the tape was seen after immersion in the hot water for 200 hours although the sealing member did not peel off from the layered body. The cause of such discoloration is assumed to be that the adhesion layer became cloudy due to absorption of water, but is not limited to this. Here, the degree of cloudiness was more advanced in Ex. 4 and 5 than in Ex. 3. From these results, it can be said that deterioration of the functional member was reduced to a certain degree in the laminated glasses of Ex. 4 and Ex. 5. It can also be said that these laminated glasses had a certain level of durability and aesthetics even in high-temperature water environments.

In the laminated glasses of Ex. 3 to Ex. 5, the sealing member was found to be suitably usable in locations less visible from inside or outside the vehicle (for example, locations overlapping the side surface of the layered body, the main surface of the layered body and the light blocking part) from the viewpoint of making resin whitening and tape discoloration less noticeable.

In the laminated glass of Ex. 6, the width of deterioration of the light control film was 3 mm after immersion in hot water at 40° C. and was 8 mm after immersion in hot water at 80° C. Further, whitening of the PVB layer was observed at the peripheral edge portion of the laminated glass. When no sealing member was provided and the edge of the light control film (entire periphery) was not protected with a barrier material, deterioration of the light control film could not be sufficiently suppressed, and it was unacceptable from the viewpoint of appearance.

### [Peeling Durability Test of Functional Layer]

The same materials as in Ex. 1 were provided. Using these materials, a layered body was produced by the same method as in Ex. 1. However, the subsequent sealing member forming step was different from that in Ex. 1 in that a portion of the layered body corresponding in position to the peripheral edge of the light control film was held by a mold (upper and lower mold parts) of predetermined shape. Thus obtained was a test sample (laminated glass) in which: the width of the protruding end portions 40e_1 and 40e_2 was shorter than in the laminated glass of the structure shown in FIG. 8; and the peripheral edge of the light control film was located more inward than the inner edge of the sealing member 40. In other words, the test sample was structured such that the protruding end portions did not overlap the peripheral edge of the light control film in plan view.

The above-prepared test sample and the separately produced laminated glass of Ex. 1 were each tested for the peeling durability of the light control film. The appearances of the test sample and the laminated glass of Example 1 were observed after the continuous application of a high AC voltage of 135 V for 1,500 hours in a high-temperature environment of 85° C.

As a result, there was seen a plurality of defects like stains in the peripheral edge portion of the light control film of the test sample. In such a defective portion, almost no transmittance change occurred at ON/OFF operations of the power supply. When a cross section of the test sample was observed with a scanning electron microscope (SEM), it was found that, in the defective portion, almost no liquid crystal was present and the layer thickness was uneven. In the laminated glass of Ex. 1, by contrast, such defects were not seen in the peripheral edge portion of the light control film. The mechanism of occurrence of the defects in the test sample is assumed to be that residual compressive stress developed in the light control film in a direction substantially perpendicular to the main surface during the formation of the sealing member and the liquid crystal peeled off from the base material to cause collapse (stress release) of the light control film during the process of the peeling durability test, but is not limited to this.

From these results, it was found that it is possible to obtain a particularly excellent laminated glass with less damage to the functional layer by forming the sealing member on the layered body in a state that the peripheral edge of the functional layer is located in the region that does not overlap the contact area of the mold with the layered body in plan view.

### REFERENCE SYMBOLS

100, 110, 200, 210, 220: Laminated glass
11: First glass plate
11a: First main surface
11b: Second main surface
11e: First end surface
12: Second glass plate
12a: Third main surface
12b: Fourth main surface
12e: Second end surface
20: Adhesive interlayer
20A, 20B: Resin sheet
30: Functional layer
31: First base material
32: Second base material
35: Active layer
37: Barrier material
40: Sealing member
40b: Base portion
40c: Connection portion
40e: Protruding end portion
40m: Intermediate protruding portion
50: Light blocking part
51: First light blocking layer
52: Second light blocking layer
60: Mold
61: First mold part
62: Second mold part
65: Injection port
68: Cavity

What is claimed is:

1. A laminated glass comprising a first glass plate, an adhesive interlayer, a functional layer, a second glass plate and a sealing member,
the first glass plate having a first main surface, a second main surface and a first end surface connecting the first main surface and the second main surface,
the second glass plate having a third main surface, a fourth main surface and a second end surface connecting the third main surface and the fourth main surface,
the adhesive interlayer being arranged in contact with the second main surface and the third main surface,
the functional layer being positioned between the second main surface and the third main surface, and
the sealing member containing a resin material and being arranged continuously from the first main surface to the fourth main surface to be in contact with the first end surface and the second end surface.

2. The laminated glass according to claim 1, wherein the sealing member is in contact with the first and second end surfaces around the entire peripheries of the first and second glass plates.

3. The laminated glass according to claim 1, wherein the sealing member is in contact with at least one of the first main surface and the fourth main surface.

4. The laminated glass according to claim 3, wherein a portion of the sealing member in contact with the at least one of the first main surface and the fourth main surface has a slope that decreases in thickness inwardly.

5. The laminated glass according to claim 1, wherein the sealing member has an intermediate protruding portion that protrudes between the first glass plate and the second glass plate.

6. The laminated glass according to claim 1, comprising an adhesion layer between the sealing member and the first glass plate and between the sealing member and the second glass plate.

7. The laminated glass according to claim 1, wherein the sealing member contains at least one resin selected from a thermoplastic elastomer (TPE), polyvinyl chloride (PVC), polyurethane (PU), polypropylene (PP), an ethylene-propylene rubber (EPDM), an acrylonitrile-butadiene-styrene resin (ABS) and a thermoplastic vulcanizate (TPV).

8. The laminated glass according to claim 1, wherein the sealing member is an injection molded resin member.

9. The laminated glass according to claim 1, wherein:
a peripheral edge portion of the functional member is apart from the sealing member; and
the adhesive interlayer is in contact with the sealing member.

10. The laminated glass according to claim 1, wherein, in plan view, a peripheral edge portion of the functional layer overlaps the sealing member.

11. The laminated glass according to claim 10, wherein a width of overlap between the sealing member and the functional layer in plan view is 1 mm or more.

12. The laminated glass according to claim 1, wherein the functional layer comprises at least one selected from a light control film, a light emitting film and a solar cell.

13. The laminated glass according to claim 1, wherein:
the functional layer is a light control film; and
the light control film contains at least one selected from a suspended particle device, polymer-dispersed liquid crystal, polymer-network liquid crystal, guest-host liquid crystal and an electrochromic material.

14. A method for producing a laminated glass, comprising:
a stacking step of preparing a layered body in which a first glass plate, a first resin sheet, a functional layer, a second resin sheet and a second glass plate are stacked in order of mention, the first glass plate having a first main surface, a second main surface and a first end surface connecting the first main surface and the second main surface, the second glass plate having a third main surface, a fourth main surface and a second end surface connecting the third main surface and the fourth main surface;
a bonding step of, after the stacking step, forming the resin sheets into an adhesive interlayer between the first glass plate and the second glass plate such that the adhesive interlayer is in contact with the second and third main surfaces and bonds the first and second glass plates together; and
a sealing step of, after the bonding step, forming a sealing member with a resin material continuously from the first main surface to the fourth main surface to be in contact with at least the first and second end surfaces.

15. The method for producing a laminated glass according to claim 14, wherein, in the sealing step, the sealing member is formed by allowing a mold to hold a peripheral edge portion of the layered body, thereby forming a cavity defined by the mold and the layered body, and filling the cavity with the resin material in a molten state.

16. The method for producing a laminated glass according to claim 15, wherein, in the sealing step, the mold holds the layered body without contacting at least one of peripheral edges of the first and second glass plates and without, in plan view, a contact area of the mold with at least one of the first and fourth main surfaces overlapping a peripheral edge of the functional layer.
